(19) United States
(12) Patent Application Publication
(10) Pub. No.: US 2024/0145792 A1
(43) Pub. Date: May 2, 2024

(54) RECHARGEABLE LITHIUM BATTERY

(71) Applicant: SAMSUNG SDI CO., LTD., Yongin-si (KR)

(72) Inventors: Dahyun KIM, Yongin-si (KR); Sanghoon KIM, Yongin-si (KR); Hyunbong CHOI, Yongin-si (KR); Sundae KIM, Yongin-si (KR); Yeji YANG, Yongin-si (KR); Hongryeol PARK, Yongin-si (KR); Sangwoo PARK, Yongin-si (KR)

(21) Appl. No.: 18/459,306

(22) Filed: Aug. 31, 2023

(30) Foreign Application Priority Data
Oct. 11, 2022 (KR) 10-2022-0129918

(51) Int. Cl. H01M 10/42; H01M 4/38; H01M 4/505; H01M 4/525; H01M 4/587; H01M 10/0525; H01M 10/0567; H01M 10/0569

(52) U.S. Cl. CPC H01M 10/4235; H01M 4/386; H01M 4/505; H01M 4/525; H01M 4/587; H01M 10/0525; H01M 10/0567; H01M 10/0569; H01M 2300/0037

(57) ABSTRACT

Provided is a rechargeable lithium battery including an electrolyte solution including a non-aqueous organic solvent, a lithium salt, and an additive; a positive electrode including a positive electrode active material; and a negative electrode including a negative electrode active material, wherein the non-aqueous organic solvent includes less than about 5 wt % of ethylene carbonate based on the total weight of the non-aqueous organic solvent, the additive includes one or more lithium compound selected from lithium tetrafluoro borate (LiBF₄), lithium difluoro(oxalato)borate (LiDFOB), lithium difluorophosphate (LiPO₂F₂), and lithium bisoxalato borate (LiB(C₂O₄)₂: LiBOB), and the positive electrode active material includes a cobalt-free lithium nickel manganese-based oxide.

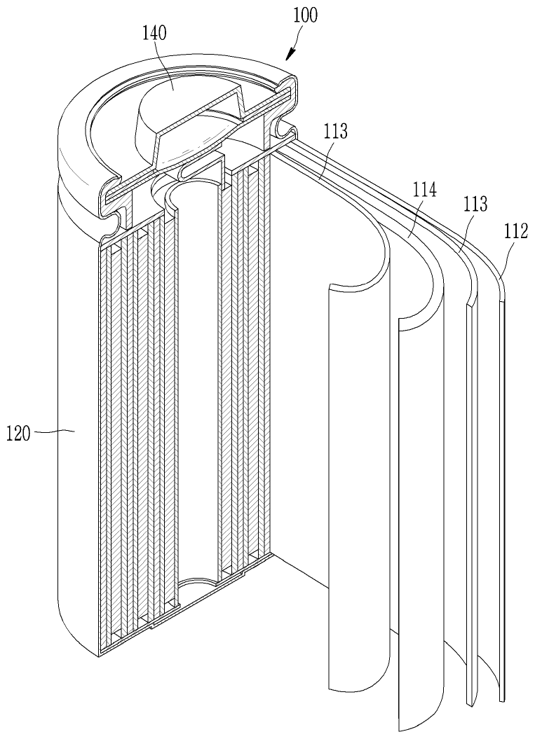

### CROSS-REFERENCE TO RELATED APPLICATION

This application claims priority to and the benefit of Korean Patent Application No. 10-2022-0129918 filed in the Korean Intellectual Property Office on Oct. 11, 2022, the entire contents of which are hereby incorporated by reference.

### BACKGROUND

### 1. Field

Embodiments of this disclosure relate to a rechargeable lithium battery.

### 2. Description of the Related Art

A rechargeable lithium battery may be recharged and has three or more times as high energy density per unit weight as a lead storage battery, nickel-cadmium battery, nickel hydrogen battery, nickel zinc battery, and the like. It may be also charged at a high rate and thus, is commercially manufactured for a laptop, a cell phone, an electric tool, an electric bike, and the like, and research on improvement of additional energy density have been actively made.

As IT devices become increasingly high-performance, high-capacity batteries are required or desired, wherein the high capacity may be realized by expanding a voltage region to increase energy density, but there is a problem of oxidizing an electrolyte solution in the high-voltage region and thereby deteriorating performance of a positive electrode.

A cobalt-free lithium nickel manganese-based oxide is a positive electrode active material not including cobalt but including nickel, manganese, and/or the like as a main component in its composition, and accordingly, a positive electrode including the same may be economical and realize high energy density and thus has drawn attention as a next generation positive electrode active material.

However, when the positive electrode including the cobalt-free lithium nickel manganese-based oxide is used in a high-voltage environment, transition metals may be eluted due to structural collapse of the positive electrode, thereby causing a problem such as gas generation inside a cell, capacity reduction, and/or the like. This transition metal elution tends to be aggravated in a high-temperature environment, wherein the eluted transition metals are precipitated on the surface of a negative electrode and may cause a side reaction and thereby increase battery resistance and deteriorate battery cycle-life and output characteristics.

Accordingly, when the positive electrode including the cobalt-free lithium nickel manganese-based oxide is used, an electrolyte solution applicable under high-voltage and high-temperature conditions is required.

### SUMMARY

An embodiment of the present disclosure provides a rechargeable lithium battery exhibiting improved high-voltage characteristics and high-temperature characteristics by combining a positive electrode including cobalt-free lithium nickel manganese-based oxide together with an electrolyte solution capable of effectively protecting the positive electrode including cobalt-free lithium nickel manganese-based oxide to reduce elution of transition metals under high-voltage and high-temperature conditions and thus to suppress or reduce structural collapse of the positive electrode.

An embodiment provides a rechargeable lithium battery including an electrolyte solution including a non-aqueous organic solvent, a lithium salt, and an additive; a positive electrode including a positive electrode active material; and a negative electrode including a negative electrode active material,

wherein the non-aqueous organic solvent includes less than about 5 wt % of ethylene carbonate based on the total weight of the non-aqueous organic solvent, the additive includes one or more lithium compound selected from lithium tetrafluoro borate (LiBF₄), lithium difluoro(oxalato)borate (LiDFOB), lithium difluorophosphate (LiPO₂F₂), and lithium bisoxalato borate (LiB(C₂O₄)₂: LiBOB), and the positive electrode active material includes a cobalt-free lithium nickel manganese-based oxide.

The non-aqueous organic solvent may be composed of chain carbonate alone (e.g., the non-aqueous organic solvent may consist of chain carbonate).

The chain carbonate may be represented by Chemical Formula 1.

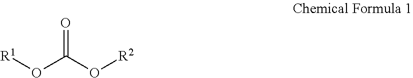

In Chemical Formula 1,

R¹ and R² may each independently be a substituted or unsubstituted C1 to C20 alkyl group.

The non-aqueous organic solvent may be a mixture of two or more solvents selected from dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

The non-aqueous organic solvent may include ethylmethyl carbonate (EMC) and dimethyl carbonate (DMC) in a volume ratio of about 0:100 to about 50:50.

The additive may be included in an amount of about 0.05 to about 5.0 parts by weight based on 100 parts by weight of the electrolyte solution for a rechargeable lithium battery.

The additive may be included in an amount of about 0.1 to about 5.0 parts by weight based on 100 parts by weight of the electrolyte solution for a rechargeable lithium battery.

The electrolyte solution may further include one or more other additives selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, 1 cyanoethylene carbonate, vinylethylene carbonate (VEC), adiponitrile (AN), succinonitrile (SN), 1,3,6-hexane tricyanide (HTCN), propene sultone (PST), propane sultone (PS), and 2-fluoro biphenyl (2-FBP).

The cobalt-free lithium nickel manganese-based oxide may include a lithium composite oxide represented by Chemical Formula 3.

LiₐNiₓMn_{y}M¹_{z}M²_{w}O_{2±b}X_{c} Chemical Formula 3

In Chemical Formula 3,

0.5≤a<1.8, 0≤b≤0.1, 0≤c≤0.1, 0≤w<0.1, 0.6≤x<1.0, 0<y<0.4, 0<z<0.1, w+x+y+z=1,

M¹ and M² are each independently one or more element selected from Al, Mg, Ti, Zr, Cr, Sr, V, B, W, Mo, Nb, Si, Ba, Ca, Ce, Cr, Fe, and Nb, and X is one or more element selected from S, F, P, and Cl.

The lithium composite oxdie represented by Chemical Formula 3 may be represented by Chemical Formula 3-1.

LiₐNiₓ₁Mn_{y1}Al_{z1}M²_{w1}O_{2±b}X_{c} Chemical Formula 3-1

In Chemical Formula 3-1,

0.5≤a<1.8, 0≤b≤0.1, 0≤c≤0.1, 0≤w1<0.1, 0.6≤x1<1.0, 0<y1<0.4, 0<z1<0.1, w1+x1+y1+z1=1,

M² is one or more element selected from Mg, Ti, Zr, Cr, Sr, V, B, W, Mo, Nb, Si, Ba, Ca, Ce, Cr, Fe, and Nb, and X is one or more element selected from S, F, P, and Cl.

In Chemical Formula 3-1, x1 may be 0.6≤x1≤0.79, y1 may be 0.2≥y1≤0.39, and z1 may be 0.01≤z1<0.1.

The negative electrode active material may include graphite, a Si composite or a mixture thereof.

The rechargeable lithium battery may have a charging upper limit voltage of greater than or equal to about 4.35 V.

An embodiment may realize a rechargeable lithium battery exhibiting improved battery stability and cycle-life characteristics by combining a positive electrode including cobalt-free lithium nickel manganese-based oxide together with an electrolyte solution capable of effectively protecting the positive electrode to secure phase transition safety of the positive electrode in a high-temperature high-voltage environment and to suppress or reduce decomposition of the electrolyte solution and a side reaction with electrodes and thereby reduce gas generation and concurrently, suppress or reduce an increase in battery internal resistance.

### BRIEF DESCRIPTION OF THE DRAWINGS

The accompanying drawing, together with the specification, illustrates an embodiment of the subject matter of the present disclosure, and, together with the description, serves to explain principles of embodiments of the subject matter of the present disclosure.

The accompanying drawing is a schematic view illustrating a rechargeable lithium battery according to an embodiment of the present disclosure.

### DETAILED DESCRIPTION

Hereinafter, a rechargeable lithium battery according to an embodiment of the present disclosure will be described in more detail with reference to the accompanying drawing. However, these embodiments are examples, the present disclosure is not limited thereto and the present disclosure is defined by the scope of the appended claims, and equivalents thereof.

In the present specification, unless otherwise defined, “substituted” refers to replacement of at least one hydrogen in a substituent or compound by deuterium, a halogen group, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

In one example of the present disclosure, “substituted” refers to replacement of at least one hydrogen in a substituent or compound by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In addition, in examples of the present disclosure, “substituted” refers to replacement of at least one hydrogen of a substituent or a compound by deuterium, a halogen, a C1 to C20 alkyl group, a C6 to C30 aryl group, a C1 to C10 fluoroalkyl group, or a cyano group. In addition, in examples of the present disclosure, “substituted” refers to replacement of at least one hydrogen of a substituent or a compound by deuterium, a halogen, a C1 to C5 alkyl group, a C6 to C18 aryl group, a C1 to C5 fluoroalkyl group, or a cyano group. In addition, in examples of the present disclosure, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

Rechargeable lithium batteries may be classified as lithium ion batteries, lithium ion polymer batteries, and lithium polymer batteries according to the presence of a separator and the type (or kind) of electrolyte solution used therein. Rechargeable lithium batteries may have a variety of suitable shapes and sizes, and include cylindrical, prismatic, coin, or pouch-type batteries, and may be thin film batteries or may be rather bulky in size. Structures and manufacturing methods for rechargeable lithium batteries pertaining to this disclosure should be readily recognizable to a person having ordinary skill in the art after reviewing this disclosure.

Herein, a cylindrical rechargeable lithium battery will be described as an example embodiment of the rechargeable lithium battery. The accompanying drawing schematically shows the structure of a rechargeable lithium battery according to an embodiment. Referring to the accompanying drawing, a rechargeable lithium battery 100 according to an embodiment includes a battery cell including a positive electrode 114, a negative electrode 112 facing to the positive electrode 114, a separator 113 between the positive electrode 114 and the negative electrode 112, and an electrolyte solution impregnating the positive electrode 114, the negative electrode 112 and the separator 113, a battery container 120 housing the battery cell, and a sealing member 140 for sealing the battery container 120.

Hereinafter, a more detailed configuration of the rechargeable lithium battery 100 according to an embodiment will be described.

A rechargeable lithium battery according to an embodiment includes an electrolyte solution, a positive electrode, and a negative electrode.

The electrolyte solution includes a non-aqueous organic solvent, a lithium salt, and an additive.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and/or the like. The ester-based solvent may include methyl acetate, ethyl acetate, n-propyl acetate, t-butyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. In addition, the ketone-based solvent may include cyclohexanone, and the like. The alcohol-based solvent may include ethanol, isopropyl alcohol, and/or the like and the aprotic solvent may include nitriles such as R-CN (wherein R is a hydrocarbon group having a C2 to C20 linear, branched, or cyclic structure and may include a double bond, an aromatic ring, and/or an ether bond), and/or the like, dioxolanes such as 1,3-dioxolane, and/or the like, and/or sulfolanes, and/or the like.

The non-aqueous organic solvent may be used alone or in a mixture of two or more. When the non-aqueous organic solvent is used in a mixture, the mixing ratio may be controlled in accordance with a suitable or desirable battery performance, which should be widely understood by those skilled in the art upon review of the present disclosure.

For example, the non-aqueous organic solvent may include less than about 5 wt % of ethylene carbonate based on the total weight of the non-aqueous organic solvent.

When the content of ethylene carbonate is greater than or equal to about 5 wt % based on the total weight of the non-aqueous organic solvent, because activity of Ni is increased when driven at a high voltage, as the oxidation number of Ni more strongly tends to be reduced from quadrivalent to divalent, the ethylene carbonate having low oxidation stability is oxidatively decomposed, thereby resulting in elution of Ni and precipitating the Ni on the negative electrode.

As an example, the non-aqueous organic solvent may be composed of chain carbonate alone (e.g., the non-aqueous organic solvent may consist of chain carbonate). In this case, excellent high-temperature storage characteristics may be realized as a resistance increase rate is significantly reduced during high-temperature storage.

In the present disclosure, the expression “composed of the chain carbonate” means that it is not mixed together with the cyclic carbonate and/or the like and includes a non-aqueous organic solvent belonging to the category of the chain carbonate alone or in combination.

In an embodiment, the chain carbonate may be represented by Chemical Formula 1.

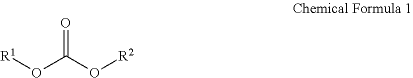

In Chemical Formula 1,

R¹ and R² may each independently be a substituted or unsubstituted C1 to C20 alkyl group.

For example, R¹ and R² in Chemical Formula 1 may each independently be a substituted or unsubstituted C1 to C10 alkyl group, and for example, R¹ and R² may each independently be a substituted or unsubstituted C1 to C5 alkyl group.

In an embodiment, R¹ and R² in Chemical Formula 1 may each independently be a substituted or unsubstituted methyl group, a substituted or unsubstituted ethyl group, a substituted or unsubstituted n-propyl group, a substituted or unsubstituted n-butyl group, a substituted or unsubstituted n-pentyl group, a substituted or unsubstituted iso-butyl group, or a substituted or unsubstituted neo-pentyl group.

For example, the non-aqueous organic solvent according to an example embodiment may be a mixture of two or more solvents selected from dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

The non-aqueous organic solvent according to an example embodiment may be a mixed solvent of dimethyl carbonate (DMC) and ethylmethyl carbonate (EMC).

The non-aqueous organic solvent may include ethylmethyl carbonate (EMC) and dimethyl carbonate (DMC) in a volume ratio of about 10:90 to about 50:50.

It may be suitable for improving battery characteristics that the non-aqueous organic solvent includes dimethyl carbonate (DMC) in an amount of greater than about 50 volume % based on the total volume of the non-aqueous organic solvent.

For example, the non-aqueous organic solvent may include ethylmethyl carbonate (EMC) and dimethyl carbonate (DMC) in a volume ratio of about 0:100 to about 40:60, or about 0:100 to about 30:70, or about 10:90 to about 40:60, or about 10:90 to about 30:70.

The non-aqueous organic solvent may further include an aromatic hydrocarbon-based organic solvent in addition to the carbonate-based solvent. In this case, the carbonate-based solvent and the aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 2.

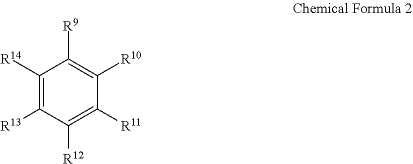

In Chemical Formula 2, R⁹ to R¹⁴ are the same or different and may be hydrogen, a halogen, a C1 to C10 alkyl group, a C1 to C10 haloalkyl group, or a combination thereof.

Examples of the aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-1 diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The lithium salt dissolved in the non-aqeuous organic solvent supplies lithium ions in a battery, enables a basic operation of a rechargeable lithium battery, and improves transportation of the lithium ions between positive and negative electrodes. Examples of the lithium salt include one or more supporting salt selected from LiPF₆, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiN(CₓF₂ₓ₊₁SO₂)(C_{y}F_{2y+1}SO₂), wherein, x and y are natural numbers, for example, an integer selected from 1 to 20, LiCl, and LiI.

The lithium salt may be used in a concentration in a range from about 0.1 M to about 2.0 M. When the lithium salt is included at the above concentration range, an electrolyte may have excellent performance and lithium ion mobility due to suitable or optimal electrolyte conductivity and viscosity.

The additive may include one or more lithium compound selected from lithium tetrafluoro borate (LiBF₄), lithium difluoro(oxalato)borate (LiDFOB), lithium difluorophosphate (LiPO₂F₂), and lithium bisoxalato borate (LiB(C₂O₄)₂: LiBOB).

The additive may be included in an amount of about 0.05 to about 5.0 parts by weight based on 100 parts by weight of the electrolyte solution for a rechargeable lithium battery. For example, the additive may be included in an amount of about 0.1 to about 5.0 parts by weight based on 100 parts by weight of the electrolyte solution for a rechargeable lithium battery.

The non-aqueous organic solvent includes less than about 5 wt % of ethylene carbonate and the electrolyte solution includes the aforementioned additive, and thereby it is possible to alleviate a decrease in battery cycle-life characteristics and a rapid increase in resistance.

When the positive electrode including a cobalt-free lithium nickel manganese-based oxide described herein below is combined together with the electrolyte solution capable of effectively protecting the positive electrode including cobalt-free lithium nickel manganese-based oxide, the transition metal elution under high-voltage and high-temperature conditions may be effectively reduced, thereby suppressing or reducing structural collapse of the positive electrode and improving high-voltage characteristics and high-temperature characteristics of a battery.

On the other hand, the electrolyte solution may further include one or more other additives selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), and 2-fluoro biphenyl (2-FBP).

By further including the aforementioned other additives, the cycle-life may be further improved and/or gases generated from the positive electrode and the negative electrode may be effectively controlled during high-temperature storage.

The other additives may be included in an amount of about 0.2 to about 20 parts by weight, about 0.2 to about 15 parts by weight, or, for example, about 0.2 to about 10 parts by weight, based on 100 parts by weight of the electrolyte solution for a rechargeable lithium battery.

When the amount of other additives is as described above, the increase in film resistance may be minimized or reduced, thereby contributing to the improvement of battery performance.

The positive electrode includes a positive electrode current collector and a positive electrode active material layer formed on the positive electrode current collector, and the positive electrode active material layer includes a positive electrode active material.

The positive electrode active material may include a cobalt-free lithium nickel manganese-based oxide.

In embodiments of the present disclosure, the cobalt-free lithium nickel manganese-based oxide as a positive electrode active material means a positive electrode active material composed mainly of nickel, manganese, etc. without including cobalt in the composition of the positive electrode active material.

For example, the cobalt-free lithium nickel manganese-based oxide may include one or more lithium composite oxides represented by Chemical Formula 3.

LiₐNiₓMn_{y}M¹_{z}M²_{w}O_{2±b}X_{c} Chemical Formula 3

In Chemical Formula 3,

0.5≤a<1.8, 0≤b≤0.1, 0≤c≤0.1, 0·w<0.1, 0.6≤x<1.0, 0<y<0.4, 0<z<0.1, w+x+y+z=1,

M¹ and M² are each independently one or more element selected from Al, Mg, Ti, Zr, Cr, Sr, V, B, W, Mo, Nb, Si, Ba, Ca, Ce, Cr, Fe, and Nb, and X is one or more element selected from S, F, P, and Cl.

The lithium composite oxide may have a coating layer on the surface, or the lithium composite oxide may be mixed together with another compound having a coating layer. The coating layer may include one or more coating element compound selected from an oxide of a coating element, a hydroxide of the coating element, an oxyhydroxide of the coating element, an oxycarbonate of the coating element, and a hydroxy carbonate of the coating element. The compound for the coating layer may be amorphous or crystalline. The coating element included in the coating layer may include Mg, Al, K, Na, Ca, Si, Ti, V, Sn, Ge, Ga, B, As, Zr, or a mixture thereof. The coating process may include any suitable processes generally used in the art as long as it does not cause any undesirable side effects on the properties of the positive electrode active material (e.g., inkjet coating, dipping), and thus, further description thereof is not necessary here.

Unlike in embodiments of the present disclosure, in the case of a positive electrode active material including the cobalt-free lithium nickel manganese-based oxide, structural instability is strong under a high-voltage condition, so that solvent decomposition and elution of transition metals, for example, Ni, may occur.

This transition metal elution phenomenon may generate deterioration of performance of a positive electrode and short-circuits cased by elution of transition metals, resulting in deteriorating cycle-life characteristics of a battery and sharply increasing resistance.

However, when the aforementioned electrolyte solution is used together, it is possible to alleviate a decrease in cycle-life characteristics and an abrupt increase in resistance of a battery.

In some embodiments, the positive electrode including the cobalt-free lithium nickel manganese-based oxide may be used in an electrolyte solution including less than about 5 wt % of ethylene carbonate may be used to effectively reduce elution of transition metals under the high-voltage and high-temperature conditions and thereby, to suppress or reduce collapse of the positive electrode structure, improving high-voltage characteristics and high-temperature characteristics of the battery.

For example, the lithium composite oxide represented by Chemical Formula 3 may be represented by Chemical Formula 3-1.

LiₐNiₓ₁Mn_{y1}Al_{z1}M²_{w1}O_{2±b}X_{c} Chemical Formula 3-1

In Chemical Formula 3-1,

0.5≤a<1.8, 0≤b≤0.1, 0≤c≤0.1, 0≤w1<0.1, 0.6≤x1<1.0, 0<y1<0.4, 0<z1<0.1, w1+x1+y1+z1=1,

M² is one or more element selected from Mg, Ti, Zr, Cr, Sr, V, B, W, Mo, Nb, Si, Ba, Ca, Ce, Cr, Fe, and Nb, and X is one or more element selected from S, F, P, and Cl.

In an embodiment, in Chemical Formula 3-1, 0.6≤x1≤0.9, 0.1≤y1<0.4, and 0<z1<0.1, or 0.6≤x1≤0.8, 0.2≤y1<0.4, and 0<z1<0.1.

For example, in Chemical Formula 3-1, x1 may be 0.6≤x1≤0.79, y1 may be 0.2≤y1≤0.39, and z1 may be 0.01≤z1<0.1.

The content of the positive electrode active material may be about 90 wt % to about 98 wt % based on the total weight of the positive electrode active material layer.

In an embodiment, the positive electrode active material layer may include a binder. The content of the binder may be about 1 wt % to about 5 wt % based on the total weight of the positive electrode active material layer.

The binder improves binding properties of positive electrode active material particles with one another and with a positive electrode current collector. Examples thereof may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The positive electrode current collector may include Al foil, but is not limited thereto.

The negative electrode includes a negative electrode current collector and a negative electrode active material layer including a negative electrode active material formed on the negative electrode current collector.

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include carbon materials. The carbon material may be any suitable, generally-used carbon-based negative electrode active material in a rechargeable lithium battery. Examples of the carbon material include crystalline carbon, amorphous carbon, and a combination thereof. The crystalline carbon may be non-shaped, or sheet, flake, spherical, or fiber shaped natural graphite and/or artificial graphite and the amorphous carbon may be a soft carbon, a hard carbon, a mesophase pitch carbonization product, calcined coke, and/or the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, Si—C composite, SiOₓ (0<x<2), a Si-Q alloy (wherein Q is an element selected from an alkali metal, an alkaline-earth metal, a Group 13 element, a Group 14 element except Si, a Group 15 element, a Group 16 element, a transition metal, a rare earth element, and a combination thereof), Sn, SnO₂, a Sn—R alloy (wherein R is an element selected from an alkali metal, an alkaline-earth metal, a Group 13 element, a Group 14 element except Sn, a Group 15 element, a Group 16 element, a transition metal, a rare earth element, and a combination thereof), and/or the like. One or more of these materials may be mixed together with SiO₂.

The elements Q and R may be selected from Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn (R does not comprise Sn), In, TI, Ge, P, As, Sb, Bi, S, Se, Te, Po, and a combination thereof.

The transition metal oxide may be a vanadium oxide, a lithium vanadium oxide, and/or the like.

In an example embodiment, the negative electrode active material may include graphite, a Si composite or a mixture thereof.

The Si composite may include a core including Si-based particles and an amorphous carbon coating layer. For example, the Si-based particles may include one or more selected from silicon particles, a Si—C composite, SiOₓ (0<x≤2), and a Si alloy.

For example, voids may be included in the central portion of the core including the Si-based particles, a radius of the central portion may correspond to about 30% to about 50% of the radius of the Si composite, an average particle diameter of the Si composite may be about 5 μm to about 20 μm, and an average particle diameter of the Si-based particles may be about 10 nm to about 200 nm.

In the present specification, an average particle diameter (D50) may be a particle size at a volume ratio of 50% in a cumulative size-distribution curve.

When the average particle diameter of the Si-based particles is within the above ranges, volume expansion occurring during charging and discharging may be suppressed or reduced, and interruption of a conductive path due to particle crushing during charging and discharging may be prevented or reduced.

The core including the Si-based particles may further include amorphous carbon, and at this time, the central portion may not include amorphous carbon, and the amorphous carbon may exist only in the surface portion of the Si composite.

Herein, the surface portion means a region from the outermost surface of the central portion to the outermost surface of the Si composite.

In addition, the Si-based particles are substantially uniformly included throughout the Si composite, for example, may be present in a substantially uniform concentration in the central portion and surface portion.

The amorphous carbon may be soft carbon, hard carbon, a mesophase pitch carbonization product, calcined coke, or a combination thereof.

For example, the Si—C composite may include silicon particles and crystalline carbon.

The silicon particles may be included in an amount of about 1 wt % to about 60 wt %, for example, about 3 wt % to about 60 wt %, based on the total weight of the Si—C composite.

The crystalline carbon may be, for example, graphite, and, for example, natural graphite, artificial graphite, or a combination thereof.

An average particle diameter of the crystalline carbon may be about 5 μm to about 30 μm.

When the negative electrode active material includes the graphite and Si composite together, the graphite and Si composite may be included in the form of a mixture, and the graphite and Si composite may be included in a weight ratio of about 99:1 to about 50:50.

In some embodiments, the graphite and Si composite may be included in a weight ratio of about 97:3 to about 80:20, or about 95:5 to about 80:20.

The amorphous carbon precursor may be coal-based pitch, mesophase pitch, petroleum-based pitch, coal-based oil, petroleum-based heavy oil, and/or a polymer resin such as a phenol resin, a furan resin, and/or a polyimide resin.

In the negative electrode active material layer, the negative electrode active material may be included in an amount of about 95 wt % to about 99 wt % based on the total weight of the negative electrode active material layer.

In an embodiment, the negative electrode active material layer may further include a binder, and optionally a conductive material (e.g., an electrically conductive material). The content of the binder in the negative electrode active material layer may be about 1 wt % to about 5 wt % based on the total weight of the negative electrode active material layer. In the negative electrode active material layer, the amount of the conductive material may be about 1 wt % to about 5 wt % based on the total weight of the negative electrode active material layer.

The binder improves binding properties of negative electrode active material particles with one another and with a negative electrode current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder and/or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylene copolymer, polyethylene oxide, polyvinylpyrrolidone, polyepichlorohydrin, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, and a combination thereof.

When the water-soluble binder is used as a negative electrode binder in the negative electrode active material layer, a cellulose-based compound may be further used to provide viscosity as a thickener. The cellulose-based compound includes one or more of carboxymethyl cellulose, hydroxypropylmethyl cellulose, methyl cellulose, and/or alkali metal salts thereof. The alkali metals may be Na, K, and/or Li. Such a thickener may be included in an amount of about 0.1 to about 3 parts by weight based on 100 parts by weight of the negative electrode active material.

The conductive material is included to provide electrode conductivity and any suitable electrically conductive material may be used as a conductive material unless it causes an undesirable chemical change in the rechargeable lithium battery. Examples of the conductive material include a carbon-based material such as natural graphite, artificial graphite, carbon black, acetylene black, ketjen black, a carbon fiber, and the like; a metal-based material including a metal powder and/or a metal fiber of copper, nickel, aluminum, silver, and/or the like; a conductive polymer such as a polyphenylene derivative; or a mixture thereof.

The negative electrode current collector may be selected from a copper foil, a nickel foil, a stainless steel foil, a titanium foil, a nickel foam, a copper foam, a polymer substrate coated with a conductive metal (e.g., an electrically conductive material), and a combination thereof.

The rechargeable lithium battery may further include a separator between the negative electrode and the positive electrode, depending on a type (or kind) of the battery. Such a separator may for example include a polyethylene separator, a polypropylene separator, a separator of a polyvinylidene fluoride separator or multi-layered separator thereof and may be a multi-layered separator such as a polyethylene/polypropylene double-layered separator, a polyethylene/polypropylene/polyethylene triple-layered separator, and/or a polypropylene/polyethylene/polypropylene triple-layered separator.

The rechargeable lithium battery may have a charging upper limit voltage of greater than or equal to about 4.35 V. For example, the charging upper limit voltage may be about 4.35 V to about 4.55 V.

Hereinafter, examples of the present disclosure and comparative examples are described. These examples, however, are not in any sense to be interpreted as limiting the scope of the disclosure.

### Manufacture of Rechargeable Lithium Battery Cells

### Example 1

LiNi_{0.75}Mn_{0.23}Al_{0.02}O₂ as a positive electrode active material, polyvinylidene fluoride as a binder, and acetylene black as a conductive material were mixed together in a weight ratio of 96:3:1 and then, dispersed in N-methyl pyrrolidone, thereby preparing a positive electrode active material slurry.

The positive electrode active material slurry was coated on a 15 μm thick Al foil, dried at 100° C., and pressed, thereby manufacturing a positive electrode.

A negative electrode active material slurry was also prepared by using a mixture of artificial graphite and Si composite in a weight ratio of 93:7 as a negative electrode active material and then, mixing together the negative electrode active material, a styrene-butadiene rubber binder, and carboxylmethyl cellulose in a weight ratio of 98:1:1 and dispersing the obtained mixture in distilled water.

As for the Si composite, a core including artificial graphite and silicon particles was coated with coal-based pitch on the surface.

The negative electrode active material slurry was coated on a 10 μm thick Cu foil, dried at 100° C., and pressed, thereby manufacturing a negative electrode.

The manufactured positive and negative electrodes were assembled with a 10 μm thick polyethylene separator to manufacture an electrode assembly, and an electrolyte solution was injected thereinto, thereby manufacturing a rechargeable lithium battery cell.

The electrolyte solution had a composition as follows.

Composition of Electrolyte Solution

Lithium salt: 1.5 M LiPF₆

Non-aqueous organic solvent: ethylmethyl carbonate:dimethyl carbonate (EMC:DMC=a volume ratio of 20:80)

Additive: 1 part by weight of LiPO₂F₂

In the composition of the electrolyte solution, “parts by weight” means the relative weight of the additive based on 100 parts by weight of the electrolyte solution for a rechargeable lithium battery (lithium salt+non-aqueous organic solvent) except the additive.

### Example 2

A rechargeable lithium battery cell was manufactured in substantially the same manner as in Example 1, except that LiPO₂F₂ in the additive composition was changed to LiBF₄.

### Example 3

A rechargeable lithium battery cell was manufactured in substantially the same manner as in Example 1, except that LiPO₂F₂ in the additive composition was changed to LiDFOB.

### Example 4

A rechargeable lithium battery cell was manufactured in substantially the same manner as in Example 1, except that LiPO₂F₂ in the additive composition was changed to LiBOB.

### Comparative Example 1

A rechargeable lithium battery cell was manufactured in substantially the same manner as in Example 1, except that the additive composition excluding LiPO₂F₂ was used.

### Comparative Example 2

A rechargeable lithium battery cell was manufactured in substantially the same manner as in Example 1, except that 5 wt % of ethylene carbonate was added based on the total weight of the non-aqueous organic solvent in the composition of the electrolyte solution.

### Comparative Example 3

A rechargeable lithium battery cell was manufactured in substantially the same manner as in Example 1, except that 1 part by weight of fluoroethylene carbonate (FEC) was added instead of LiPO₂F₂ in the composition of the electrolyte solution.

### Comparative Examples 4 to 9

Rechargeable lithium battery cells were manufactured in substantially the same manner as in Examples 1 to 4 and Comparative Examples 1 and 2, except that the positive electrode active material was changed to LiCoO₂.

### Comparative Examples 10 to 15

Rechargeable lithium battery cells were manufactured in substantially the same manner as in Examples 1 to 4 and Comparative Examples 1 and 2, except that the positive electrode active material was changed to LiNi_{0.5}Co_{0.2}Al_{0.3}O₂.

### Comparative Examples 16 to 21

Rechargeable lithium battery cells were manufactured in substantially the same manner as in Examples 1 to 4 and Comparative Examples 1 and 2, except that the positive electrode active material was changed to LiNi_{0.8}Co_{0.1}Mn_{0.1}O₂.

### Example 5

A rechargeable lithium battery cell was manufactured in substantially the same manner as in Example 1, except that the non-aqueous organic solvent was changed to dimethyl carbonate at a 100 volume ratio.

### Examples 6 to 8

Rechargeable lithium battery cells were manufactured in substantially the same manner as in Example 1, except that the mixing ratio of ethylmethyl carbonate and dimethyl carbonate was changed to a volume ratio of 30:70 (Example 6), a volume ratio of 40:60 (Example 7), and a volume ratio of 70:30 (Example 8).

### Evaluation 1: Evaluation of High-Temperature Storage Characteristics

The rechargeable lithium battery cells according to Examples 1 to 8 and Comparative Examples 1 to 21 were measured with respect to initial DC internal resistance (DC-IR) as ΔV/ΔI (change in voltage/change in current), and after changing a maximum energy state inside the rechargeable lithium battery cells into a full charge state (SOC 100%) and storing the cells in this state at a high temperature (60° C.) for 30 days, the cells were measured with respect to DC resistance to calculate a DC-IR increase rate (%) according to Equation 1, and the results are shown in Table 1, Table 2, and Table 5.

DC-IR increase rate={(DC-IR after 30 days)/(initial DC-IR)}×100% [Equation 1]

### Evaluation 2: Evaluation of High-Temperature Cycle-Life Characteristics

The rechargeable lithium battery cells of Examples 1 to 4 and Comparative Examples 1 to 3 were once charged and discharged at 0.2 C and then, measured with respect to charge and discharge capacity.

In addition, the rechargeable lithium battery cells according to Examples 1 to 4 and Comparative Examples 1 to 3 were charged to a charge upper limit voltage (4.4 V) and discharged to 2.5 V at 0.2 C under a constant current condition and then, measured with respect to initial discharge capacity.

While 200 cycles charged and discharged under conditions of 0.33 C charge (CC/CV, 4.4 V, 0.025 C cut-off)/1.0 C discharge (CC, 2.5V cut-off) at 45° C., the rechargeable lithium battery cells were measured with respect to discharge capacity. A ratio of the discharge capacity to the initial discharge capacity was shown as a capacity recovery rate (%, recovery) in Table 4.

### Evaluation 3: Measurement of Gas Generation after High-Temperature Storage

The rechargeable lithium battery cells according to Examples 1 to 4 and Comparative Examples 1 to 3 were allowed to stand at 60 O (for 7 days and then, measured with respect to each gas generation amount (ml) on the 1^{st} and 7^{th} days by using Refinery Gas Analysis (RGA), and the results are shown in Table 3.

TABLE 1

| | | DC-IR after | DC-IR |
|---|---|---|---|
| | | storage at high | Increase |
| | Initial | temperature (60° C.) | rate (60° C., |
| | DC-IR | for 30 days | 30 days) |
| | (mOhm) | (mOhm) | (%) |
| Ex. 1 | 42.09 | 43.77 | 104 |
| Ex. 2 | 42.08 | 45.03 | 107 |
| Ex. 3 | 42.12 | 44.23 | 105 |
| Ex. 4 | 42.13 | 44.66 | 106 |
| Comp. Ex. 1 | 42.17 | 46.81 | 111 |
| Comp. Ex. 2 | 42.34 | 52.50 | 124 |
| Comp. Ex. 3 | 42.28 | 50.90 | 120 |

TABLE 2

| | | | DC-IR after | DC-IR |
|---|---|---|---|---|
| | | | storage at high | Increase |
| | | Initial | temperature (60 ° C.) | rate (60° C., |
| Positive electrode | | DC-IR | for 30 days | 30 days) |
| active material | | (mOhm) | (mOhm) | (%) |
| LiNi_{0.75}Mn_{0.23}Al_{0.02}O₂ | Ex. 1 | 42.09 | 43.77 | 104 |
| | Ex. 2 | 42.08 | 45.03 | 107 |
| | Ex. 3 | 42.12 | 44.23 | 105 |
| | Ex. 4 | 42.13 | 44.66 | 106 |
| | Comp. Ex. 1 | 42.17 | 46.81 | 111 |
| | Comp. Ex. 2 | 42.34 | 52.50 | 124 |
| | Comp. Ex. 3 | 42.28 | 50.90 | 1.20 |
| LiCoO₂ | Comp. Ex. 4 | 42.24 | 51.53 | 122 |
| | Comp. Ex. 5 | 42.23 | 51.10 | 121 |
| | Comp. Ex. 6 | 42.25 | 51.12 | 121 |
| | Comp. Ex. 7 | 42.24 | 51.53 | 122 |
| | Comp. Ex. 8 | 42.25 | 51.97 | 123 |
| | Comp. Ex. 9 | 42.29 | 49.90 | 118 |
| LiNi_{0.5}Co_{0.2}Al_{0.3}O₂ | Comp. Ex. 10 | 42.28 | 52.00 | 123 |
| | Comp. Ex. 11 | 42.27 | 52.41 | 124 |
| | Comp. Ex. 12 | 42.28 | 52.43 | 124 |
| | Comp. Ex. 13 | 42.29 | 52.44 | 124 |
| | Comp. Ex. 14 | 42.31 | 52.46 | 124 |
| | Comp. Ex. 15 | 42.41 | 53.01 | 125 |
| LiNi_{0.8}Co_{0.1}Mn_{0.1}O₂ | Comp. Ex. 16 | 42.31 | 51.00 | 121 |
| | Comp. Ex. 17 | 42.30 | 50.80 | 120 |
| | Comp. Ex. 18 | 42.33 | 51.20 | 121 |
| | Comp. Ex. 19 | 42.34 | 51.20 | 121 |
| | Comp. Ex. 20 | 42.40 | 52.40 | 124 |
| | Comp. Ex. 21 | 42.43 | 52.00 | 123 |

TABLE 3

| | Amount of gas generated after storage | | |
|---|---|---|---|
| | at high temperature (60° C.) | | |
| | 1 day | 7 days | Increase rate |
| | (mL) | (mL) | (%) |
| Ex. 1 | 1.05 | 1.46 | 139 |
| Ex. 2 | 0.99 | 1.35 | 136 |
| Ex. 3 | 0.98 | 1.30 | 133 |
| Ex. 4 | 1.02 | 1.35 | 132 |
| Comp. Ex. 1 | 1.11 | 1.68 | 151 |
| Comp. Ex. 2 | 1.35 | 3.69 | 273 |
| Comp. Ex. 3 | 1.21 | 2.80 | 231 |

TABLE 4

| | Capacity | Increase rate relative to |
|---|---|---|
| | recovery rate | Comparative Example 2 |
| | (45° C., 200 cy, %) | (%) |
| Ex. 1 | 96.2 | 129 |
| Ex. 2 | 96.4 | 129 |
| Ex. 3 | 95.9 | 128 |
| Ex. 4 | 96.1 | 128 |
| Comp. Ex. 1 | 94.7 | 127 |
| Comp. Ex. 2 | 74.8 | 100 |
| Comp. Ex. 3 | 85.4 | 114 |

TABLE 5

| | | DC-IR after | DC-IR |
|---|---|---|---|
| | | storage at high | Increase |
| | Initial | temperature (60° C.) | rate (60° C., |
| | DC-IR | for 30 days | 30 days) |
| | (mOhm) | (mOhm) | (%) |
| Ex. 1 | 42.09 | 43.77 | 104 |
| Ex. 5 | 42.11 | 46.10 | 109 |
| (EMC:DMC = 0:100) | | | |
| Ex. 6 | 42.13 | 45.21 | 107 |
| (EMC:DMC = 30:70) | | | |
| Ex. 7 | 42.15 | 45.78 | 109 |
| (EMC:DMC = 40:60) | | | |
| Ex. 8 | 42.21 | 47.52 | 113 |
| (EMC:DMC = 70:30) | | | |
| Comp. Ex. 2 | 42.34 | 52.50 | 124 |

Referring to Tables 1, 2 and 5, the example compositions of the present disclosure in which the electrolyte solution and Co-free positive electrode active material were combined, exhibited a decrease in the DC-IR increase rate and improved high-temperature storage characteristics. When the additive according to embodiments of the present disclosure is not included (Comparative Example 1), when other additives are included (Comparative Example 3), when EC is included in an amount of greater than or equal to 5 wt % (Comparative Example 2), and when other positive electrode active materials are included even with the composition of the electrolyte solution (Comparative Examples 4 to 21), it can be expected that the DC-IR increase rate increases after high-temperature storage, thereby resulting in a decrease in battery cycle-life characteristics.

It can be that the composition of the non-aqueous organic solvent showed a more excellent effect when the volume ratio of EMC:DMC was 0:100 to 50:50.

Referring to Table 3, the gas generation amounts after the high-temperature storage were significantly reduced.

Referring to Table 4, it can be seen that the high-temperature charge/discharge characteristics are improved by reducing the DC-IR increase rate in the composition in which the electrolyte solution and the Co-free positive electrode active material according to embodiments of the present disclosure are combined.

While the subject matter of this disclosure has been described in connection with what is presently considered to be practical example embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: rechargeable lithium battery
112: negative electrode
113: separator
114: positive electrode
120: battery case
140: sealing member

What is claimed is:

1. A rechargeable lithium battery, comprising:
an electrolyte solution comprising a non-aqueous organic solvent, a lithium salt, and an additive;
a positive electrode comprising a positive electrode active material; and
a negative electrode comprising a negative electrode active material,
wherein the non-aqueous organic solvent comprises less than about 5 wt % of ethylene carbonate based on the total weight of the non-aqueous organic solvent,
the additive comprises one or more lithium compound selected from lithium tetrafluoro borate (LiBF₄), lithium difluoro(oxalato)borate (LiDFOB), lithium difluorophosphate (LiPO₂F₂), and lithium bisoxalato borate (LiB(C₂O₄)₂: LiBOB), and
the positive electrode active material comprises a cobalt-free lithium nickel manganese-based oxide.

2. The rechargeable lithium battery of claim 1, wherein:
the non-aqueous organic solvent is composed of chain carbonate alone.

3. The rechargeable lithium battery of claim 2, wherein:
the chain carbonate is represented by Chemical Formula 1: 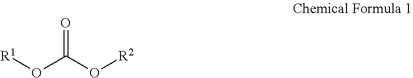
wherein, in Chemical Formula 1
R¹ and R² are each independently a substituted or unsubstituted C1 to C20 alkyl group.

4. The rechargeable lithium battery of claim 1, wherein:
the non-aqueous organic solvent is a mixture of two or more solvents selected from dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

5. The rechargeable lithium battery of claim 1, wherein:
the non-aqueous organic solvent comprises ethylmethyl carbonate (EMC) and dimethyl carbonate (DMC) in a volume ratio of about 0:100 to about 50:50.

6. The rechargeable lithium battery of claim 1, wherein:
the additive is included in an amount of about 0.05 to about 5.0 parts by weight based on 100 parts by weight of the electrolyte solution for a rechargeable lithium battery.

7. The rechargeable lithium battery of claim 1, wherein:
the additive is included in an amount of about 0.1 to about 5.0 parts by weight based on 100 parts by weight of the electrolyte solution for a rechargeable lithium battery.

8. The rechargeable lithium battery of claim 1, wherein:
the electrolyte solution further comprises one or more other additives selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), and 2-fluoro biphenyl (2-FBP).

9. The rechargeable lithium battery of claim 1, wherein:
the cobalt-free lithium nickel manganese-based oxide comprises a lithium composite oxide represented by Chemical Formula 3:
LiₐNiₓMn_{y}M¹_{z}M²_{w}O_{2±b}X_{c} Chemical Formula 3
wherein, in Chemical Formula 3,
0.5≤a<1.8, 0≤b≤0.1, 0≤c≤0.1, 0≤w<0.1, 0.6≤x<1.0, 0<y<0.4, 0<z<0.1, w+x+y+z=1,
M¹ and M² are each independently one or more element selected from Al, Mg, Ti, Zr, Cr, Sr, V, B, W, Mo, Nb, Si, Ba, Ca, Ce, Cr, Fe, and Nb, and X is one or more element selected from S, F, P, and Cl.

10. The rechargeable lithium battery of claim 9, wherein:
the lithium composite oxide represented by Chemical Formula 3 is represented by Chemical Formula 3-1:
LiₐNiₓ₁Mn_{y1}Al_{z1}M²_{w1}O_{2±b}X_{c} Chemical Formula 3-1
wherein, in Chemical Formula 3-1,
0.5≤a<1.8, 0≤b≤0.1, 0≤c≤0.1, 0≤w1<0.1, 0.6≤x1<1.0, 0<y1<0.4, 0<z1<0.1, w1+x1+y1+z1=1,
M² is one or more element selected from Mg, Ti, Zr, Cr, Sr, V, B, W, Mo, Nb, Si, Ba, Ca, Ce, Cr, Fe, and Nb, and X is one or more element selected from S, F, P, and Cl.

11. The rechargeable lithium battery of claim 10, wherein:
in Chemical Formula 3-1, x1 is 0.6≤x1≤0.79, y1 is 0.2≤y1≤0.39, and z1 is 0.01≤z1<0.1.

12. The rechargeable lithium battery of claim 1, wherein:
the negative electrode active material comprises graphite, a Si composite or a mixture thereof.

13. The rechargeable lithium battery of claim 1, wherein:
the rechargeable lithium battery has a charging upper limit voltage of greater than or equal to about 4.35 V.
